(19) United States
(12) Patent Application Publication
(10) Pub. No.: US 2018/0044108 A1
(43) Pub. Date: Feb. 15, 2018

(54) Trash Can Liner Box Support and Dispensing Arrangement

(71) Applicant: Sybil Ackerman, E. Norwich, NY (US)

(72) Inventor: Sybil Ackerman, E. Norwich, NY (US)

(21) Appl. No.: 15/673,491

(22) Filed: Aug. 10, 2017

Related U.S. Application Data
(60) Provisional application No. 62/373,382, filed on Aug. 11, 2016.

(51) Int. Cl. B65F 1/06; B65F 1/14; B65B 67/12

(52) U.S. Cl. CPC B65F 1/062; B65F 1/068; B65B 67/1266; B65F 1/1421

(57) ABSTRACT

Trash can embodiments dispense plastic liners. First, a holder secured to a bottom wall of a trash container includes a base, and four posts, each having a corresponding pivotable arm biased from a retracted position into an extended position. The arms are pivotally coupled to respective posts to releasably retain a box of liners therein, as liners are withdrawn from the box. Second, a particularly formed trash container includes a floor wall positioned above the bottom wall to divide the container into lower and upper chambers. The side wall has a first opening interconnected with the lower chamber, and a second opening interconnected, with the second opening and the lower and upper chamber. The floor wall has an opening interconnected with the second side wall opening. The first side wall opening provides clearance for the box. The second opening, provides clearance for a first liner protruding from the box.

### CROSS REFERENCES TO RELATED APPLICATIONS

This application claims priority on U.S. Provisional Application Ser. No. 62/373,382, filed on Aug. 11, 2016, the disclosures of which are incorporated herein by reference.

### FIELD OF THE INVENTION

The present invention relates to the use of plastic liners in a trash can, and more particularly to apparatus configured for use in supporting a box of plastic liners within a trash can, for dispensing and use of the liners therefrom.

### BACKGROUND OF THE INVENTION

A centralized system for community trash collection and disposal began in England around 1875, and was similarly utilized in the U.S. shortly thereafter. The system necessitated the use of a garbage bin, receptacle, trash can, etc., to temporarily store refuse, until it would to be collected. There are a number of early patents to improved trash/garbage cans (e.g., U.S. Pat. No. 1,218,632 to Derry).

Some of the early trash can-related patents include the use of a liner. For example, U.S. Pat. No. 816,989 to Moler is for a “Garbage Can” that includes a body, and a removable cover, where the body is configured with hooks to therein support a canvas sack having a corresponding series of eyelets, and a drawstring for contracting the mouth of the sack. U.S. Pat. No. 2,634,880 to Gravatt is for a “Disposable Liner for Garbage Cans.”

Since the location where such disposable trash can liners are to be stored may be. very inconvenient with respect to where the trash can was actually deployed, certain inventions offered basic storage and dispensing capabilities for the trash can liners.

For example, U.S. Pat. No. 3,481,112 to Bourgeois was for a bag dispensing device having a repository for a supply roll of disposable trash can liners. The roll of liners was received within a base plate having a semi-cylindrical trough, and a frame/housing was received over the base, and was used to support the trash bag/liner in an, inflated tillable position. U.S. Pat. No. 3,760,975 to Nilsson was similarly constructed, and was directed to a “Wastebasket Having a Supply of Wastebags.” U.S. Pat. No. 3,451,453 to Heck discloses use of a “dispenser” that may be “removably mounted” in, trash receptacle, being “inserted from the upper end of the receptacle,” where the dispenser has “an opening therein for dispensing the disposable liners.” U.S. Pat. No. 5,803,300 to DeMars is similarly for a “Trash Container with Bag Holder.”

The present invention offers improvements over these and other similar inventions.

### OBJECTS OF THE INVENTION

It is an object of the invention to provide an arrangement for supporting a box of trash can liners within a trash can for dispensing therefrom.

It is another object of the invention to provide a box of trash can liners that is formed to better facilitate dispensing of the liners from within the trash can.

It is a further object of the invention to provide an improved trash can particularly configured to receive and support a box of trash can liners.

It is another object of the invention to provide an improved trash can and corresponding box of liners than are configured to facilitate hands-free dispensing of an empty unused liner upon removal of a filled trash can liner.

It is also an object of the invention to provide an arrangement usable for retrofitting an existing trash can, and which may support dispensing of liners from a commercially available box of trash can liners.

Further objects and advantages of the invention will become apparent from the following description and claims, and from the accompanying drawings.

### SUMMARY OF INVENTION

This Summary is provided to introduce a selection of concepts in a simplified from that are further described below in the Detailed Description. This Summary is not intended to identify key features or essential features of the claimed subject matter, nor is it intended to be used to limit the scope of the claimed subject matter.

In accordance with a first embodiment of the present invention, a holder member may be received into a conventional trash container that has a bottom wall, and a side wall extending away from the bottom wall to form a cavity. The holder member is configured to releasably receive and retain a box of trash can liners in the bottom of the trash container, for dispensing of the liners therefrom, one at a time. The holder member may include a base member, four posts, and four pivotable arms. The base member may be configured to be received onto the bottom wall within the cavity of the trash container. A first post may extend away from the base member, from a first side of the base member, proximate to a first end of the base member. A second post may extend away from the base member, from the first side of the base member, proximate to a second end of the base member. A third post may extend away from the base member, from a second side of the base member, proximate to the first end of the base member. The fourth post may extend away from the base member, from the second side of the base member, proximate to the second end of the base member. A first arm may be pivotally coupled to the first post at a height above the base member, and a second arm may be pivotally coupled to the second post at the same height above the base member, with each of the first and second arms being configured to pivot between an extended position and a retracted position. A third arm may be pivotally coupled to the third post at the same height above the base member, and a fourth arm may be pivotally coupled to the fourth post at the same height, with each of the third and fourth arms configured to pivot between similar extended and retracted positions. A torsion spring for each arm may bias the respective arm away from the base toward the extended position. A first connecting bar may be fixedly secured to both the first arm and the second arm, to permit a user to easily move both arms simultaneously into the retracted position. A second connecting bar may similarly be fixedly secured to both the third arm and the fourth arm. The holder may be secured to the container, using adhesive or mechanical fasteners. Each of the arms may be formed with a triangular shaped periphery, with a fast side of the triangular shape configured to be parallel to the base when the arm is in the extended position, and with a second side of the triangular shape configured to be perpendicular to the base when the arm is in the retracted position.

In another embodiment, a box of plastic trash can liners may be particularly formed to be adhered to either the base of the holder member, or instead be adhered directly to the bottom wall of the conventional trash container. The box of plastic trash can liners may be formed with a bottom wall, and one or more side walls that extend from the bottom wall and terminate at a top wall that may have an opening therein. A plurality of trash can liners may be particularly joined and successively packed in the cavity of the box to be successively drawn one at a time through the opening in the top wall of the box. The plurality of trash can liners being particularly joined and successively packed may include a top portion of each liner being releasably interconnected with a rear bottom portion of a previous liner. Also, in one embodiment, the top portion of each of the successively packed plurality of liners may be releasably interconnected with the rear bottom portion of the previous liner at each of four equally spaced positions. In another embodiment, the top portion of each of the successively packed plurality of liners may be releasably interconnected with the rear bottom portion of the previous liner at each of two locations, being on opposite sides of the previous liner, The box may also include an adhesive that may exhibit low peel adhesion properties. The adhesive may be applied to one or more regions on an outer surface of the bottom wall of the box. The low peel adhesion property of the adhesive may be sufficient to prevent detachment of the box when a single liner is pulled through the opening, but permit removal of the box by a user-applied force. The box may also include a peelable non-stick cover sheet releasably received over the adhesive at each of the one or more regions, similar to those used on adhesive bandages.

Another trash can embodiment may include a bottom wall, a side wall, and a floor wall. The side wall may be configured to extend away from the bottom wall at a periphery of the bottom wall, to a distal end, to thereby form a cavity. The floor wall may be positioned at a height above the bottom wall to divide the cavity into a lower chamber and an upper chamber. The lower chamber may thus be positioned between the bottom wall and the floor walk and the upper chamber may be positioned between the floor wall and the distal end of the side wall. The lower chamber may be sized to receive a box of trash can liners therein. The side wall may have a first opening interconnected with the lower chamber, where the first opening in the, side wall is formed to provide clearance with respect to a profile of the box of trash can liners. The side wall may also have a second opening, with a portion of the second opening being coextensive with a portion of the first opening, and where the second opening is interconnected with each of the lower chamber and the upper chamber. The second opening in the side wall may be formed to provide clearance with respect to a liner protruding from the box of trash can liners. The floor wall may include an opening that may interconnect with the second opening in the side wall, so that these openings permit sliding of the box of liners into the lower chamber while the first liner protrudes from the box. This facilitates easy withdrawal of the first liner from the box, with the user reaching down towards the bottom of the trash can.

### BRIEF DESCRIPTION OF THE DRAWINGS

The description of the various example embodiments is explained in conjunction with appended drawings, in which:

FIG. 1 illustrates a front view of a prior art trash can.

FIG. 2 is the front view of the prior art trash can of FIG. 1, but shown with a disposable liner having been received therein.

FIG. 3 illustrates a front view of a prior art trash can having a pivotable lid, and showing a first embodiment of a box of trash can liners formed in accordance with the present invention having been secured therein.

FIG. 4 illustrates the trash can and the box of trash can liners of FIG. 3, but is shown with the first trash can liner having been withdrawn from the box and expanded to fill the trash can, and to overhang the lip of the trash can.

FIG. 5 in an enlarged front view of the box of trash can liners shown in FIG. 3.

FIG. 6 is a cross-sectional view through the box of trash can liners of FIG. 5.

FIG. 7A is a top view of the box of trash can liners of FIG. 5.

FIG. 7B is a bottom view of the box of trash can liners of FIG. 5.

FIG. 8 illustrates the front view of the trash can and box of trash can liners of FIG. 4, but shown after the first liner has been filled with trash and sealed, and after being lifted from the can to automatically elevate the second/subsequent liner.

FIG. 9 is a side view of the trash can and box of trash can liners of FIG. 8.

FIG. 10 shows the side view of the trash can and box of trash can liners illustrated in FIG. 9, but also shows an alternate embodiment for attachment and sequencing of the successive trash can liners within the box.

FIG. 11 shows the side view of the trash can and box of trash can liners illustrated in FIG. 10, but is shown with the filled trash can liner having been moved beyond the front of the trash can, and with the lid of the trash can being lowered to help sever the connection between the filled and the empty/subsequent trash can liner.

FIG. 12 shows the side view of the trash can and box of trash can liners illustrated in FIG. 11, but is shown after the lid was fully lowered, and the filled trash can liner was severed from the empty/subsequent trash can liner.

FIG. 13 illustrates a front view of the trash can and box of trash can liners of FIG. 12, but is shown with the lid having been opened, and the empty/subsequent trash can liner having been opened and wrapped over the lip of the trash can.

FIG. 14 is a side view of a prior art trash can, with a holder in accordance with the present invention secured to the bottom of the can, and with a box of trash can liners being retained therein.

FIG. 14A shows an alternate embodiment of the holder of the present invention that may be secured to the bottom of the can, and used to prevent the box, of trash can liners from being elevated when liners are being dispensed therefrom.

FIG. 15 is an inserted side view of the holder shown within the trash can of FIG. 14, and also showing the box of trash can liners, positioned beneath the pivotable retaining arms.

FIG. 15A is the side view of FIG. 15, but showing the box of trash can liners initially being inserted past the pivotable arms.

FIG. 16 is a top view of the holder and box of trash can liners shown in FIG. 15.

FIG. 17 is side view of a trash can formed in accordance with another embodiment of the present invention.

FIG. 18 is a front view of the trash can of FIG. 17.

FIG. 19 is a view of the floor/wall of the trash can embodiment of FIG. 18.

FIG. 20 is a side view of a box of trash can liners, with the box opened and a first liner having been partially withdrawn therefrom.

### DETAILED DESCRIPTION OF THE INVENTION

As used throughout this specification, the word “may” is used in a permissive sell se .e., meaning having the potential to), rather than the mandatory sense (i.e., meaning must). Similarly, the words “include”, “including”, and “includes” mean including but not limited to.

The phrases “at least one”, “one or more” and “and/or” are open-ended expressions that are both conjunctive and disjunctive in operation, For example, each of the expressions “at least one of A, B and C”, “one or more of A, B, and C”, and “A, B, and/or C” mean all of the following possible combinations: A alone; or B alone; or C alone; or A and B together; or A and C together; or B and C together; or A, B and C together.

Also, the disclosures of all patents, published patent applications, and non-patent literature cited within this document are incorporated herein in their entirety by reference.

Furthermore, the described features, advantages, and characteristics of any particular embodiment disclosed herein, may be combined in any suitable manner with any of the other embodiments disclosed herein.

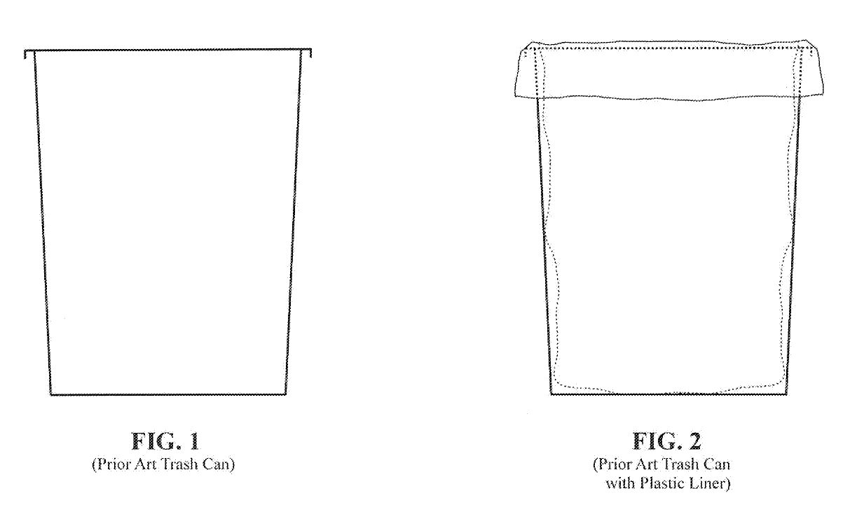

FIG. 1 illustrates a front view of a prior art trash can, while FIG. 2 shows the prior art trash can of FIG. 1 after a disposable liner has been placed therein, and opened up and draped over the flanged upper lip of the trash can. This arrangement requires that a subsequent disposable liner be retrieved from a box of such liners, from wherever they may be stored. The various embodiments of the present invention are each particularly adapted to remedy this inconvenience.

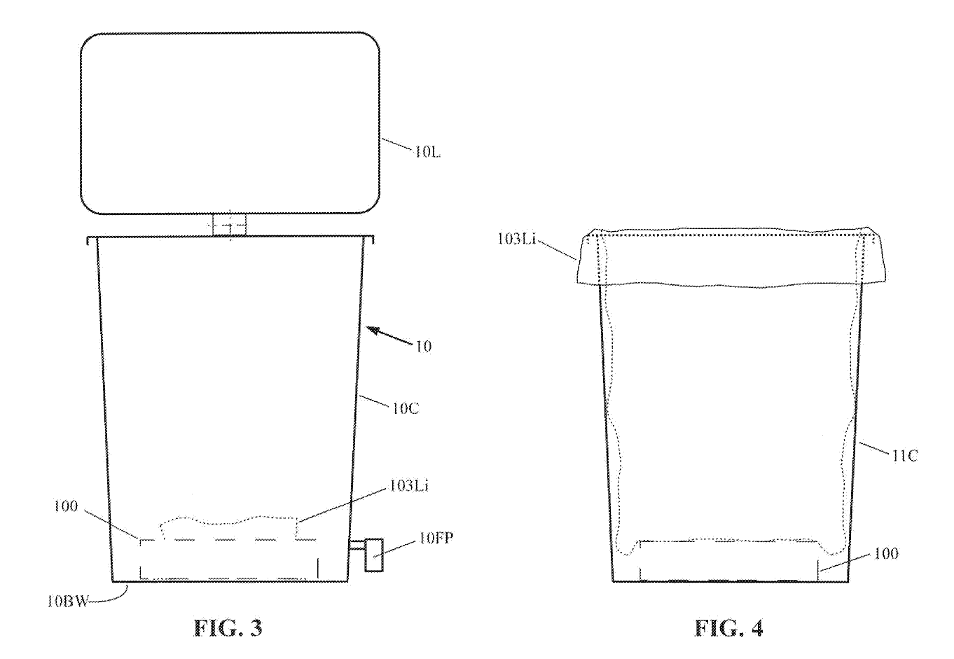

FIG. 3 illustrates a front view of a prior art trash can assembly 10 that may have a can 10C with a lid 10L pivotally coupled thereto, and an associated lid actuation mechanism, including a foot pedal 10FP configured to cause pivotal opening and closing of the lid.

Secured to the bottom wall 10BW of the can 10C is a first embodiment of a box assembly with trash can liners 100. The box 100, although shown secured to the bottom of the can 10C of trash can assembly 10, may similarly be secured to the bottom of any other trash can known in the art, including, but not limited to, the prior art trash can without a lid, as illustrated in FIG. 1. FIG. 4 illustrates a prior art trash can 11C formed without a pivotal lid, and which trash can is shown with the first trash can liner 103Li having been withdrawn from the box assembly 100 and expanded to fill the trash can, and to overhang the lip of the trash can,

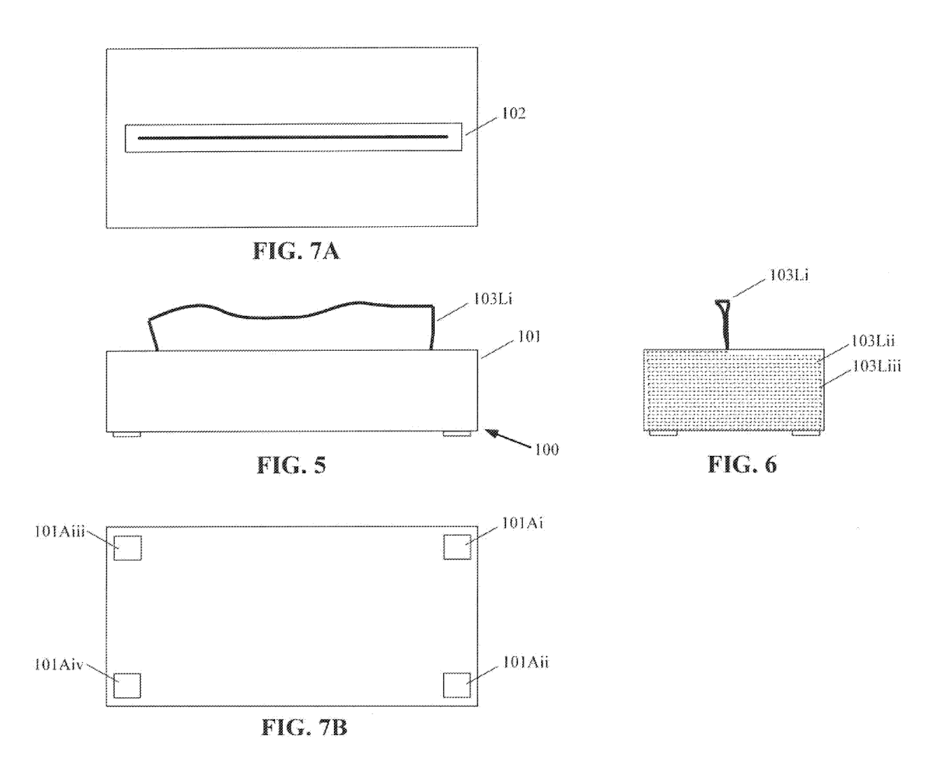

FIGS. 5-7B show enlarged front, cross-sectional, and top and bottom views, respectively, of the box assembly 100 with trash can liners therein (e.g., 103Li, 103Lii, 103Lii, etc.). The box assembly 100 may contain trash can liners that may be particularly joined and successively packed therein (see e.g., FIG. 6), which is discussed further hereinafter.

The box 101 of box assembly 100 may have a suitably formed opening 102 on its upper surface, through which the succession of liners (e.g., 103Li, 103Lii, 103Liii, etc.) may be drawn. The bottom surface of box 101 may be secured to the bottom wall 10BW of the trash can 10C. In one embodiment, an adhesive may be applied to the bottom surface of box 101, after which the box assembly 100 may be placed into contact with the bottom wall 10BW of the trash can 10C. After all the liners have been used, the empty box 101 may be removed. An adhesive with a low peel adhesion value (in Newtons per 10 mm to the nearest 0.1 N/10 mm, or Pounds per inch), may preferably be used on the box 101 to facilitate its removal, and the adhesive may also be a low tack adhesive.

It is noted that while the “tack” and the “peel adhesion” of an adhesive are usually correlated, they are different. The “tack” e.g., low tack, medium tack, or high tack) refers to how quickly a bond is formed when the adhesive in brought into contact with a surface. A high tack adhesive therefore is more appropriately used when loads may be applied quickly, and the adhesive will not be allowed to set for a very long time (i.e., little “dwell time”), The “peel adhesion” refers to the measured amount of force that is necessary to remove a tape specimen from a test panel (i.e., to break the bond therebetween), when removed at a controlled angle (typically 90 degrees or 180 degrees), at a standard rate, and after a pre-defined dwell time.

For the box 101 of box assembly 100, the adhesive should possess sufficient peel adhesion to prevent loosening/separation of the box from the can when a single liner is being pulled through opening 102, which may result in roughly a 1-3 pound separation load being applied to the box. However, the adhesive should not possess such high adhesion as to prevent the bond from being temporary and inhibit removal by a user, and thus should not be greater than 7-10 pounds in one embodiment, and not greater than 12-15 pounds in another embodiment, and not greater than 17-20 pounds in yet another embodiment. A repositionable adhesive may be, used, such as the Repositionable 75 Spray Adhesive made by 3M Corp. Rather than applying an adhesive to the box 101 a preformed adhesive material may be secured to the bottom of the box, and the exposed adhesive side may be covered with a non-stick cover. A double-sided tape, a poster mounting block, and/or a pressure sensitive adhesive may also be used. The adhesive material used may, for example, be that which is shown by U.S. Pat. No. 4,061,820 to Magid, or U.S. Pat. 4,358,489 to Green, or U.S. Pat. No. 5,672,402 to Kreckel, or any other similar adhesive products.

Such an adhesive may be applied onto at least one location on the bottom surface of box 100, which may be a central location thereon. Alternatively, an adhesive product may be used at two locations on the bottom surface of the box 101, which locations may be at opposite ends of the box. Alternatively, as seen in FIG. 7B, a plurality of such adhesive products (e.g., 101Ai, 101Aii, 101Aiii, 101Aiv) may be used, and may be applied at each corner of the bottom. surface of the box.

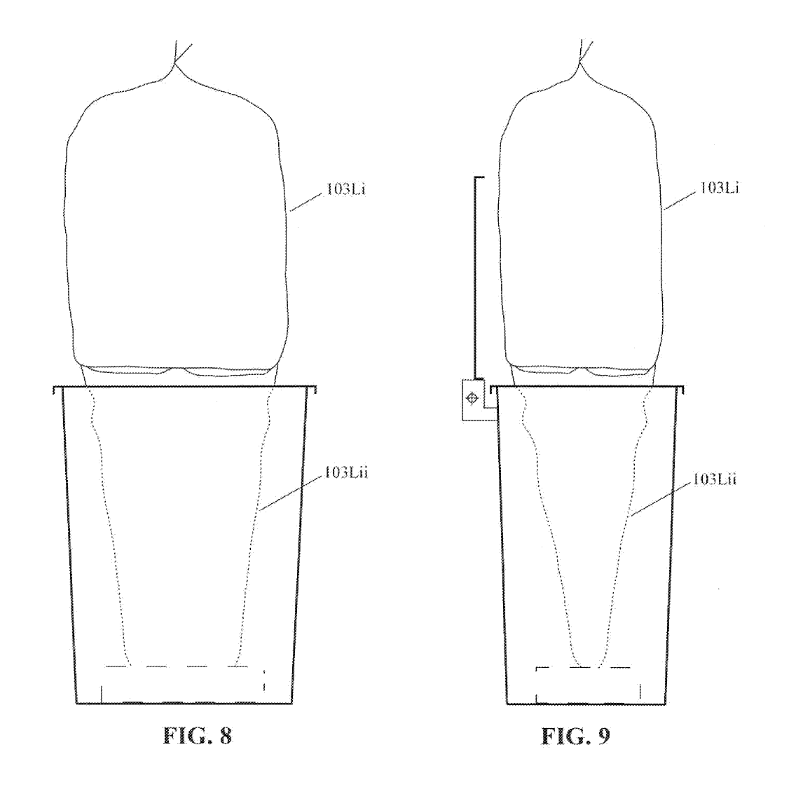

The trash can liners (103Li, 103Lii, 103Liii, etc.) may be particularly packed into the box 101, and may be particularly interconnected so that removal of each liner through the opening 102 of the box may eventually lead to the subsequent liner also being automatically withdrawn therefrom. As shown in FIGS. 8-9, the top of each of the successive liners (e.g., 103Lii) may be releasably coupled (e.g., a small perforated interconnection) with the bottom of the previous liner (e.g., 103Li), and may be interconnected at each of four equally spaced positions (i.e., four corners of the top of the successive liner interconnected with four corners of the bottom of the previous liner). The plastic of the liners may be joined at those positions for a short perforated length or a small perforated circular interconnection. Where the successive liners are interconnected with the previous liner at four locations (e.g., at the 0 degree, 90 degree, 180 degree, and 270 degree radial locations), the successive liners may each automatically expand as the previous bag is expanded by the user, or is expanded upon being filled with trash items deposited therein.

In an alternative arrangement, the successive liner(s) may be interconnected at two locations on opposite sides of the center bottom of the previous liner, and may be packed to be centered and aligned to directly exit the opening 102 in the box 101. This may reduce any tendency of the subsequent liner(s) to inadvertently separate while being drawn by the previous liner through the opening 102 in box 101.

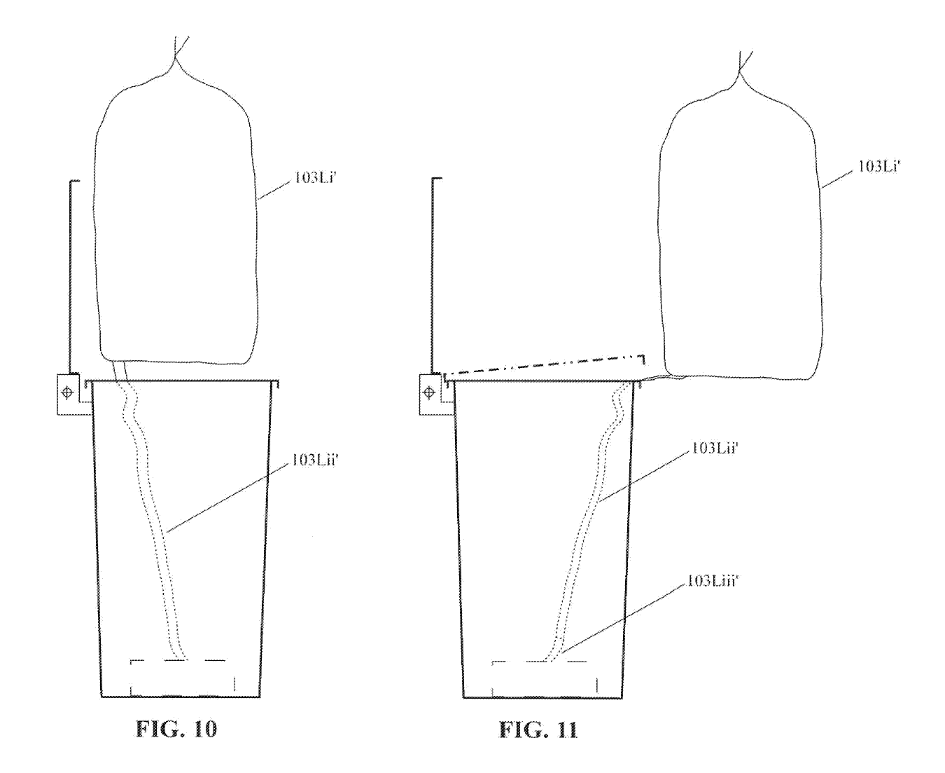

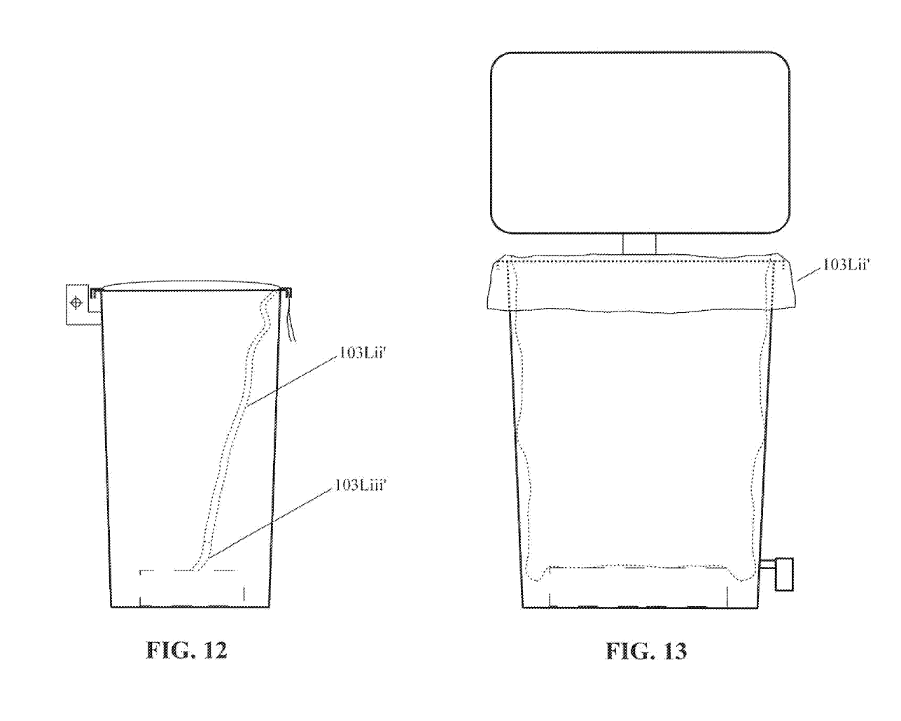

In yet another alternative arrangement. as shown in FIGS. 10-11, the successive liner (e.g., 103Lii′) may be interconnected with the rear of the bottom of the previous liner (e.g., 103Li′). As the user lifts the first/previous liner (e.g., 103Li′) from the trash can assembly 10 after it is has been filled, and may naturally move the filled liner towards the front (or side) of the trash can, as seen in FIG. 11, the user may also remove his/her foot from the foot pedal 10FP of the trash can assembly to lower the lid 10L, and also may then begin lowering the filled liner 103Li′ to the ground to cause its separation from the next liner 103Lii′. This may result in the subsequent liner (e.g.. 103Lii′) being positioned as shown in FIG. 12. Therefore, the subsequent liner (e.g., 103Lii′) may thereafter be easily grasped by the user at the top of the trash cart assembly 10, and may be easily and quickly opened and draped over the lip of the can 10C, as shown in FIG. 13, with the successive liner 103Liii′ already partially withdrawn from the box.

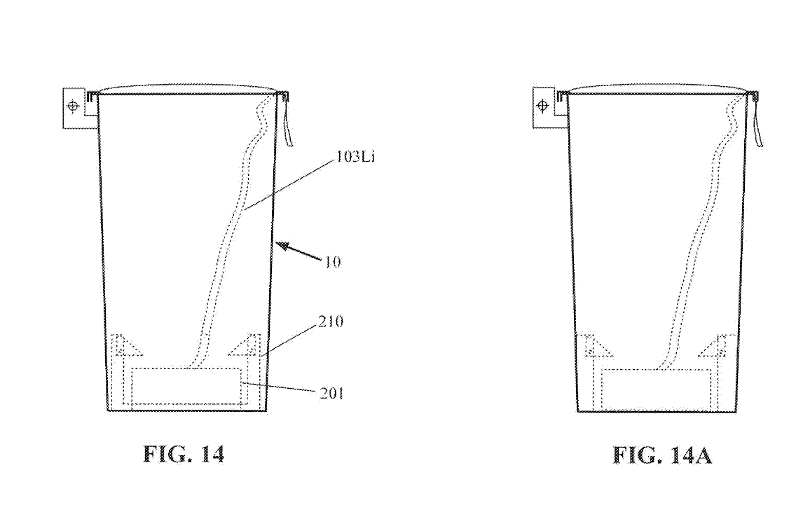

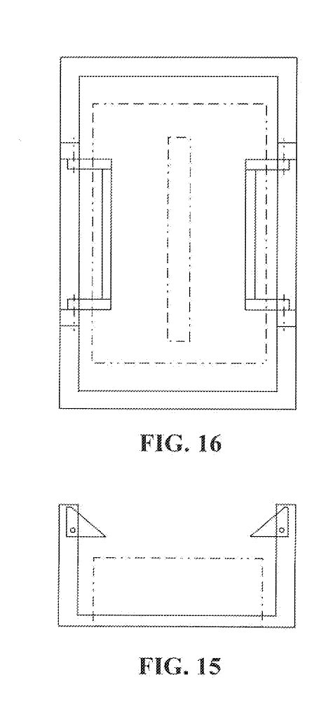

FIG. 14 illustrates a side view of the prior art trash can assembly 10, with a holder 210 of the present invention being secured to the bottom of the can, and with a box 201 of trash can liners being retained therein. The holder 210 is shown by itself within the side and top views of FIGS. 15-16, respectively. The holder 210 may be used to retain the box 201 at the bottom of the trash can assembly 10L. The holder 210 may be permanently secured thereat using mechanical fasteners, or using a high tack adhesive, etc.; or may alternatively be temporarily secured thereat using any of the other adhesive materials discussed hereinabove.

The holder 210 may have, a frame that may support at least a first pivotable arm 241, and a second pivotable arm 251. The arms 241/251 may be configured to pivot from an extended, position, as seen in FIG. 15, where they may be positioned on opposite sides of the box 201 to overlie it and prevent it from being freely lifted upward when liners are being withdrawn therefrom, to a retracted position, as seen in FIG. 15A, where the empty box may be manually removed from the bottom of the can. (Note that in one embodiment, only one of the arms may need to be moved into the retracted position to permit the box to be angled upwardly for removal from the holder in the trash can).

Each of the arms 241/251, which may be triangular-shaped, may be pivotally coupled to, and supported at a desired height above the bottom of the trash can 10C by, a respective post 243/253. The arms 241/251 may be biased toward the extended position by a respective torsion spring (not shown), and respective stop members (e.g., stops 241S and 251S) may limit the biased pivoting of each of the arms to the extended position shown in FIG. 15. The bottom/base of the frame may simply be formed as a straight member that may directly connect arm 243 to arm 253. and may also be made of a metallic material so as to have a very low height (see FIG. 15A), so as not to cause the box 201 to teeter-totter appreciably when placed thereon.

Alternatively, the frame may be U-shaped to permit it to surround a portion of the box 201. Alternatively, as illustrated in FIG. 16, the frame may have four sides—sides 261, 262, 263, and 264, which may form an opening into which the box 201 may be placed, and which may sit upon the bottom of the can 10C. Another set of arms 242/252 may be similarly supported by posts 244/254. The second set of arms 242/252 may be respectively connected to the first set of arm 241/251 using connecting bars 271/272, so that by depressing the bar 271, both of the arms 241 and 242 may be actuated into the retracted position. Similarly, by depressing the bar 272, both of the arms 251 and 252 may be actuated into the retracted position. A flexible cable may also connect one of the arms 241 or 242 to one of the arm 251 or 252 on the other side, so that actuating one of the bars 271 or 272, may cause the other bar and corresponding arms to correspondingly be actuated into the retracted position.

In another embodiment, shown in FIG. 14A, no frame is utilized, as the posts that support the arms may be secured directly to the sides of the trash can 10C.

In yet another embodiment, each of the posts may be integrally formed with the container portion of the trash can, and the arms may be pivotally coupled to the integral posts, as described above.

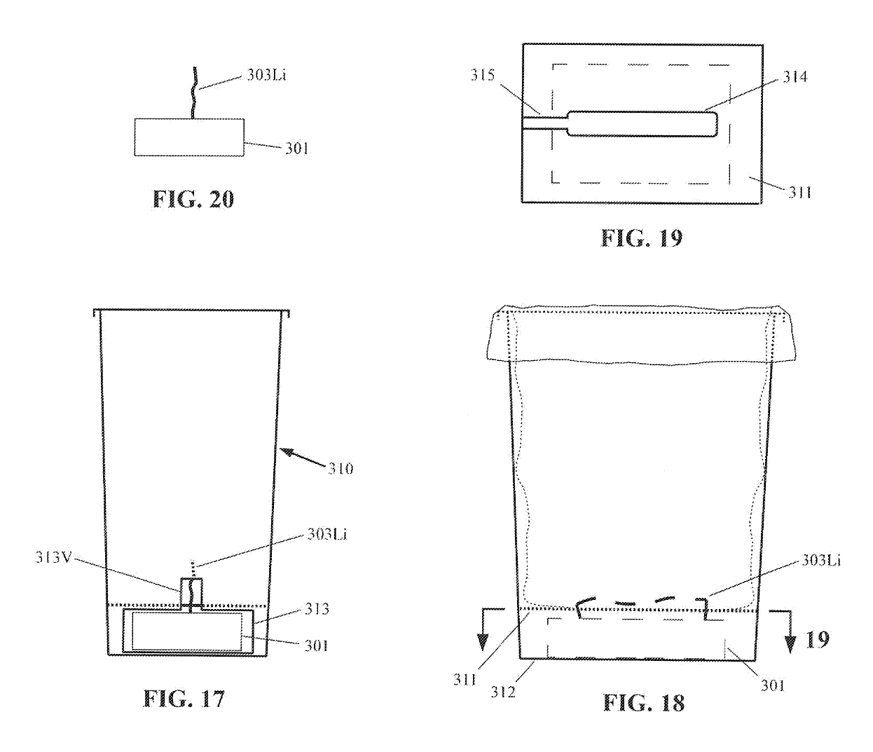

FIGS. 17-18 show side and front views of a trash can embodiment 310, which may also be formed with or without the conventional lid and associated lid actuation mechanism and foot pedal.

The trash can 310 may be formed with a conventional upstanding wall and bottom wall 312 to form a container, and may additionally be formed with a floor wall 311 that may be positioned at a height above the bottom wall to form a lower chamber being sufficiently large to accommodate a box 301 of trash can liners to be received therein. An opening 313 may be formed in one side of the upstanding wall of the trash can, being sufficiently sized with respect to the profile of the box of liners 301, to permit ingress and egress of the box from beneath the floor 311. The floor 311 may have, as seen in FIG. 19, an opening 314 formed therein, through which the interconnected liners may be pulled into the container portion of the trash can. In one embodiment, the opening 314 may begin proximate to a first end of the floor wall 311, and end proximate to a second end of the floor wall.

To accommodate easy transmitting of the first trash can liner (e.g., 303Li) from the box 301 through the opening 314 in the floor 311, the opening 313 in the side of the upstanding wall may have a periphery that may include a vertically oriented opening portion 313V that may protrude above the height of the floor. Also a secondary opening 315 in floor 311 may interconnect the opening 314 with the vertically oriented opening portion 313V in the upstanding wall. Therefore, the box 301 of liners may be opened and the first trash can liner (e.g., 303Li) may be withdrawn slightly from the opening, in the box as shown in FIG. 20, after which the box may be fed through the opening 313 in the upstanding wall, with the slightly withdrawn first trash can liner 303Li being simultaneously passed through vertically oriented opening portion 313V, and then through opening 315 and opening 314. The top of the slightly withdrawn first trash can liner 303Li protruding above the floor 311 may then be easily grasped by the user by reaching down into the container portion of trash can 300. Note that the two openings 314 and 315 with different widths may be replaced in another embodiment by a single opening, the width of which may be fairly narrow like opening, 315, or which may he somewhat wider for easy insertion of the first trash can liner, being as wide as opening 314.

While illustrative implementations of one or more embodiments of the present invention are provided hereinabove, those skilled in the art and having the benefit of the present disclosure will appreciate that further embodiments may be implemented with various changes within the scope of the present invention. Other modifications, substitutions, omissions and changes may be made in the design, size, materials used or proportions, operating conditions, assembly sequence, or arrangement or positioning of elements and, members of the exemplary embodiments without departing from the spirit of this invention.

Accordingly, the breadth and scope of the present disclosure should not be limited by any of the above-described example embodiments, but should be defined only in accordance with the following claims and their equivalents.

What is claimed is:

1. A box of plastic liners for a trash can, said box of plastic liners comprising;
a box formed with a bottom wall, one or more side walls extending from said bottom wall, and terminating at a top wall; said top wall comprising an opening;
a low tack, low peel adhesion adhesive applied to one or more regions on an outer surface of said box;
a peelable non-stick cover sheet releasably received over said adhesive at each of said one or more regions;
a plurality of trash can liners being particularly joined and successively packed in said box to be successively drawn one at a time through said opening in said top wall of said box; and
wherein said plurality of trash can liners being particularly joined and successively packed comprises a top portion of each liner being releasably interconnected with a rear bottom portion of a previous liner of said successively packed plurality of liners.

7. The plastic liners according to claim 1 wherein said top portion of each of said successively packed plurality of liners is releasably coupled with said rear bottom of said previous liner at each of four equally spaced positions.

3. The plastic liners according to claim 1 wherein said top portion of each of said successively packed plurality. of liners is releasably interconnected with said rear bottom of said previous liner at each of two locations on opposite sides of the previous liner.

4. The plastic liners according to claim 1 wherein said low peel adhesion adhesive is sufficient to prevent detachment of said box when a single liner is pulled through said opening, but permit removal of said box by a user-applied force.

5. A trash can, comprising:
a container, said container comprising a bottom wall, and a side wall extending away from said bottom wall to form a cavity;
a holder member, said holder member comprising:
a base member, said base member configured to be received onto said bottom wall within said cavity of said container;
a first post configured to extend away from said base member, from a first side of said base member, proximate to a first end of said base member;
a second post configured to extend away from said base member, from said first side of said base member, proximate to a second end of said base member;
a third post configured to extend away from said base member, from a second side of said base member, proximate to said first end of said base member;
a fourth post configured to extend away from said base member, from said second side of said base member, proximate to said second end of said base member;
a first arm pivotally coupled to said first post at a height above said base member, and a second arm pivotally coupled to said second post at said height above said base member, each of said first and second arms configured to pivot between an extended position and a retracted position;
a third arm pivotally coupled to said third post at said height above said base member, and a fourth arm pivotally coupled to said fourth post at said height above said base member, each of said third and fourth arms configured to pivot between an extended position and a retracted position;
a respective torsion spring for each of said arms, each said torsion spring configured to bias said respective arm away from said base toward said extended position;
a first connecting bar fixedly secured to each of said first arm and said second arm;
a second connecting bar fixedly secured to each of said third arm and said fourth arm; and
wherein said holder is secured to said container.

6. The trash can according to claim 5, wherein each of said arms is triangular shaped, with a first side of said triangular shape configured to be parallel to said base when said arms are in said extended position, and a second side of said triangular shape configured to be perpendicular to said base when said arms are in said retracted position.

7. The trash can according to claim 5, wherein said holder is secured to said bottom wall of said container using a high peel adhesion adhesive.

8. The trash can according to claim 5, wherein said holder is secured to said bottom wall of said container using mechanical fasteners.

9. The trash can according to claim 5, wherein said base and said posts of said holder are each integrally formed with said container.

10. The trash can according to claim 6, further comprising a box of plastic liners, said box of plastic liners comprising:
a box formed with a bottom wall, one or more side walls extending from said bottom wall, and terminating at a top wall; said top wall comprising an opening;
a plurality of trash can liners being particularly joined and successively packed in said box to be successively drawn one at a time through said opening in said top wall of said box; and
wherein said plurality of trash can liners being particularly joined and successively packed comprises a top portion of each liner being releasably interconnected with a rear bottom portion of a previous liner of said successively packed plurality of liners;

11. The trash can according to claim 10 wherein said top portion of each of said successively packed plurality of liners is releasably interconnected with said rear bottom of said previous liner at each of four equally spaced positions.

12. The trash can according to claim 11 wherein said top portion of each of said successively packed plurality of liners is releasably interconnected with said rear bottom of said previous liner at each of two locations on opposite sides of the previous liner.

13. The trash can according to claim 10 further comprising:
a low tack, low peel adhesion adhesive applied to one or more regions on an outer surface of bottom wall of said box; and
a peelable non-stick cover releasably received over said, adhesive at each of said one or more regions.

14. The trash can according to claim 13 wherein said low peel adhesion adhesive is sufficient to prevent detachment of said box when a single liner is pulled through said opening, but permit removal of said box by a user-applied force.

15. A trash can comprising:
a bottom wall;
a side wall, said side will configured to extend away horn periphery of said bottom wall to a distal end, to form a cavity;
a floor wall, said floor wall positioned at a height above said bottom wall to divide said cavity into a lower chamber, being positioned between said bottom wall and said floor wall, and an upper chamber, being positioned between said floor wall and said distal end of said side wall, said lower chamber being sized to receive a box of trash can liners therein;
wherein said side wall comprises a first opening interconnected with said lower chamber, said first opening in said side wall formed to provide clearance with respect to a profile of the box of trash can liners;
wherein said side wall comprises a second opening, a portion of said second opening being coextensive with a portion of said first opening, said second opening being interconnected with said lower chamber, and configured to extend above said floor wall and be interconnected with said upper chamber, said second opening in said side wall formed to provide clearance with respect to a liner protruding from the box of trash can liners; and
wherein said floor wall comprises an opening, said opening in said floor wall configured to interconnect with said second opening in said side wall.
